(19) United States
(12) Patent Application Publication
(10) Pub. No.: US 2007/0120842 A1
(43) Pub. Date: May 31, 2007

(54) Method for manipulating a three-dimensional surface

(75) Inventor: Raul Hess, Hordt (DE)

Correspondence Address: HENRY M FEIEREISEN, LLC, 350 FIFTH AVENUE, SUITE 4714, NEW YORK, NY, 10118, US

(73) Assignee: Peguform GmbH, Botzingen (DE)

(21) Appl. No.: 10/572,755

(22) PCT Filed: Sep. 24, 2004
(86) PCT No.: PCT/EP04/10724

§ 371 Date: Mar. 20, 2006

(30) Foreign Application Priority Data
Sep. 26, 2003 (DE) 10345081.1

(51) Int. Cl. G06T 15/00

(52) U.S. Cl. 345/419; 264/400

(57) ABSTRACT

The invention relates to a method for removing material from a three-dimensional surface (1) of any shape in a multi-layered manner by means of a material removing agent (9) such as a laser that acts in points on a surface. According to said method, a surface structure (2) is removed from the three-dimensional surface (1), the surface is approximated by a polygon network, and raster images are associated with the polygons (19) of the polygon network (18). Said polygons are projected onto the machining region (1)) of the material removing means. A series of superimposed polygon networks being associated with a layer of material, each of the polygon networks being associated with a layer in which material is removed, if the information stored on the projected raster image indicates the planned removal of material. The use of polygon networks (18) for removing material in a multi-layered manner ensures a very precise removal of material from a surface structure (2) of any shape, thus creating a highly precise three-dimensional surface structure.

Up to now, the layer by layer removal of material from a mold cavity for the production of any three-dimensional surface structure was carried out by means of an etching process or a galvanic process, where a positive mold with the desired surface design is covered with metal, which is then used as a negative mold for producing the desired form part or respective foil. These various methods always require many process steps in order to produce the negative mold for only one single surface configuration. As a result, with each change in the surface configuration, the same method steps must be repeated, resulting in additional cost and significant expenditure of time in order to obtain surface structures with such precision, which is required when producing for example a very natural looking leather grain. Up to now, two methods for applying a grain to molds in an economic way are common; a first one is the etched grain, where the surface of the mold is partially masked and selectively removed by means of an etching fluid. This method also works with reservations in layers which then produce a highly steplike transition between the grain peaks and the grain valleys. In addition, difficulties arise when more complex geometric patterns of the surface have to be grained.

Another method is the so-called galvano process. With this method, a positive model, a so-called model to be leather-grained is clad in foil (or leather) which incorporates the desired pattern, for example, a leather grain. In a duplicating molding process the grain is transferred to a negative mold, which in turn is used to produce a (positive-) bath-model and placed in a galvanic bath where a metal layer is then deposited. The so obtained galvanic mold needs to be reinforced, but could also be utilized with certain methods for the productions of parts like those where the surface is not subjected to too much stress. Particularly popular are the slush-method and the spray-skin method. However, each of these latter methods is time consuming and costly.

Due to the large expenditures connected with these methods of the prior art used in industrial settings, there are efforts to produce the surface structure by means of a removal agent. A versatile removal agent is a laser beam. The technology for removing material by means of lasers is known, for example, from DE3939866 in the field of laser engraving. Removal of material by means of evaporating a surface layer by laser is known from DE 4209933 C2. The laser beam is being expanded by means of pivotable deflection mirrors and guided across a computer generated reference line. The reference lines form a raster grid. The grid is scanned several times by the laser beam along reference lines that are offset in anglewise manner, to thereby remove material by evaporation. Varying the direction of the laser tracks through rotation of the working plane by a certain angle prevents systematic excess of material in the border layer. The result is a network like pattern in the raster lines. This technology is predominantly utilized for two-dimensional surfaces. Thus, an even removal of material in the raster grid is realized by this technology as taught in the patent.

Guiding the laser line by line in paths (raster lines), respectively tracks, in each of the areas to be manipulated by the laser, is disclosed in the DE 100 329 81 A1. The tracks are made area by area onto a moving work piece. In order to avoid that a sharp line forms at the border area where the tracks overlap, which can occur through the excessive removal of material in the overlap regions, the border areas are being offset from each other at each removal step. In other words, when removing line by line in an area, the laser does not stop at the end of the line, but continues only in close range of that line. The end point of the removal is then at close range to the line but differs from line to line. Since the endpoints are thus statistically distributed about a mean value of the line, an optical defect is not detectable. This method is suitable for the material removal in raster grids which are all in one plane. However, as soon as the raster grids are sloped relative to one another, a different amount of material is removed by the removal agent, when the removal agent moves away from the raster grid. This would require that each end point be recorded, that the material removal be determined and the deficiency for the adjacent raster grid be corrected. Due to these circumstances, the method can be utilized for three-dimensional surfaces only with additional high expenditure in computation.

According to the teaching in DE 101 166 72 A1, rough and fine structures are processed differently, such that fine structure areas are processed by means of laser and rough structure areas by a gouging device. This technology is suitable especially for machining metal surfaces, for example as applied to pressure cylinders. Machining rough surfaces is carried out by means of mechanical removal devices.

As conventionally known, material removal by means of laser can also be realized for complex structures, which is for example utilized in micro-machining of materials. There are also known methods for the removal of material on large surfaces by means of laser.

It is an object of the invention to remove material in order to realize a given surface structure, such as for example a leather grain, or any three-dimensionally configured surface. Thus, this object of the invention is to propose a method for providing molds or models of any shape with a three-dimensional surface structure, which closely resemble either a natural or any other chosen surface structure. Such a surface structure is for example embodied in the grain of leather which is characterized in that the grain peaks occupy various areas and are of various heights and where there is a uniform transition between grain peaks and grain valleys. It is another object of the invention to avoid the appearance of separating lines or border lines when removing material.

This object is solved according to the invention with the method of claim 1, which can be applied to a variety of materials and which is time efficient, as compared to the methods of the prior art and not limited in application with respect to the geometry of surface structures. In addition, the method according to the invention should be capable of being applied to any combination of materials. Removing one or more layers of any shaped three-dimensional surface is carried out by means of a point removal from the surface, such as with a laser, for imparting a surface structure on a three-dimensional surface and wherein the surface is approximated by at least one polygon network, wherein each polygon of the polygon network is assigned to a specific area to be manipulated by the laser. The surface approximated by the polygon network is scanned by means of a scanning device. The scanning device, i.e. a galvanic scanner, defines the area to be manipulated by the laser.

The original three-dimensional computer model or master model of the work piece should be described by a suitably fine-meshed polygon network, which in turn is derived from the CAD-(spline)-description of the work piece.

The three-dimensional corners of the polygons correspond to two-dimensional points in one or more master texture-bitmaps, whereby the polygons are translated into the two-dimensional space of the bitmap. The value of the grey level of the bitmap corresponds to the required surface removal on the work piece.

Subsequently, the surfaces to be worked on for each of the layers are defined. The grey level bitmaps for the polygons of each of the layers result from a parallel projection of the polygons and bitmaps of the master model onto the polygon of the surface to be worked on. The surface structure is thus described by at least one raster image, wherein each area to be worked on is placed in its entirety within the focal area of the laser. The point location of the polygon corners in the three-dimensional space corresponds to the two-dimensional position of the coordinates on the surface of the raster images. The material removal can be realized in several layers, wherein each layer is associated with its own polygon network. In an advantageous embodiment, no area to be worked on shares any border section with any of the areas which were worked on previously in a layer.

With the method for the selective removal of material layers on a form part, configuration of a structure is realized such as for example texturing a work piece with a leather grain, which is characterized by a transition between the grain peaks and the grain valleys that is as uniform as possible. Furthermore, with respect to the topology of the work piece, the method should have virtually unlimited possibilities, that is, there should be no limitations such as for example applicable only to cylinder surfaces as in the prior art; see for example DE 101 16 672 A1.

According to DE 420 99 33 C2, the formation of a surface structure can be realized for example by evaporation of the material by means of a laser beam. This computer controlled beam is guided along predetermined raster lines across the work piece. For large surfaces, the treatment is carried out generally in sections (compare also DE 10032981 A1).

Certain surfaces and grains have to be described so their structure can be realized with a known method for removing the material, in particular, a laser method. A distinction must thus be made between the description of the topology, that is, the geometry of the work piece and the grain, that is, the desired fine structure of the surface which is produced with the work piece by a molding method.

Generally, for the topology description of certain free form surfaces in the automotive industry, NURBS (non-uniform rational B-splines) are used. Since a complex geometry cannot be satisfactorily described by a single NURBS surface, several so-called NURBS patches are assembled adjacent to each other. Oftentimes, these are cut to size (trimmed) prior to assembly, whereby NURBS curvatures located on NURBS surfaces are utilized.

Prior to manipulating this topology with the laser, it must be divided into working areas. The size of the work area is chosen ideally such that when the scanner is positioned in a certain way (approximately vertical to the area to be manipulated), the area can be scanned simply by positioning the galvanic mirrors. Furthermore, any change in distance between scanner and working area should be kept small. When selecting the size of the work area, the object in each case is not to create an undesirable variation in the material removal, respectively material removed per time unit, either through the positioning angle of the laser or through a change in distance between the surface and the scanner. Each work area must be positioned entirely within the focus of the laser.

The possible working area at a certain position of the scanner can be described through the focal square when using a plane field lens. The distance between the scanner and the central plane of the focal square is determined by the focal distance of the laser optics. The height of the work area at predetermined maximal error of the thickness of the removed layer, is given by the maximum depth of focus (deviation from the focal distance), and its side length by the corresponding maximum radial deflection of the galvanic mirrors in the scanner. Within the focal square, the work section can be approximated by a polygon, the corners of which are all on one surface, which ideally has exactly the distance of the focal distance relative to the laser optics and positioned vertical to the direction of the laser beam in the central position of the deflection mirrors. This polygon then corresponds to a surface area of the area for manipulation and is realized by projecting the polygon onto the NURBS surface which must be brought entirely within the focal square.

The entire topology of the surface to be manipulated by laser is thus described by a grid of connected polygons of different sizes and shapes. In this manner, the polygon edges are selected independent of the NURBS-patches which describe the surface to be manipulated, that is, there is a high probability that one or more points on the polygon are located on one patch and one or more points on the polygon are located on the adjacent NURBS-patch.

For the description of the fine structure of the surface, each polygon will be matched with a raster image (bitmap) to improve the manipulating capability through the control program of the laser. Thereby, the size of the image spot corresponds minimally to the size of the cross section of the laser light beam and the grey level (brightness) or the color level (intensity) of the image spot corresponds to the depth of the structure at this particular spot. A white spot would thus mean, that no material was removed, whereas a black spot indicates that a maximal material removal has taken place (or vice versa).

A still greater precision can be realized when describing the laser beam through several image spots in the bitmap. The disadvantage hereby resides in the resulting enlargement of the bitmap and the correspondingly higher storage requirement and need for computing capacity in the electronic controls.

The encoding of the bitmap corresponds thus to the maximum number of layers, that is, at a 256 grey level (=8 bit) per image spot, a maximum of 256 layers can be described. To store this raster image, several different computer formats with corresponding compressing algorithms are available, which result in a much reduced storage requirement.

Generally, the polygon will rarely be of square shape. Thus, the corners of the polygon in the three-dimensional space are associated to each of the corresponding spots on the bitmap in 2D coordinates (texture coordinates). Through a corresponding arrangement of the polygons, it is also possible to combine the texture coordinates of several polygons on one bitmap. In addition, when computing and storing the polygons with the corresponding bitmaps, the angle direction for the laser tracks can already be pre-set. (Compare DE 4209 933 C2). The laser tracks need not necessarily follow the raster lines of the bitmap, but by applying computer graphics methods it is possible to compute the brightness value for the grid lines running obliquely to the laser track, by utilizing anti-aliasing algorithms (compare a line running diagonally on the computer screen).

When manipulating the work piece, a laser device must be utilized where the scanner, in which the galvanic mirrors are housed, is of adequate maneuverability relative to the work piece so it can be brought into the most vertical position to each polygon situated at a distance to the focal distance of the laser optics, that is, it should correspond to that position which was the basis for the computation of the polygons.

By controlling the laser device in an economical way, it is necessary to coordinate the polygons in the data records such that they are read in sequence by the electronic controller, to prevent that the scanner follows wrong tracks.

Another object is to avoid creating separating lines, which arise in the area where the laser track ends and the next one begins (compare DE 100 329 81 A1). The danger of this occurring is especially high at the edges of the two adjoining polygons.

This object is solved in that the thickness of the layer is reduced to such an extent that the resulting borderline becomes negligibly small in its height as compared to the total height of the grain and thus, is no longer visible. A compounding of the separating line-error at the polygon edges is avoided, in that each layer to be removed is associated with its own independent three-dimensional polygon network. This can be freely selected when taking into account the above constraints. In addition, attention must be given that the polygon edges, which may overlap (it is inevitable), are not superposed. Otherwise, the separating line-error will be compounded. Thus, when looking at any point on the surface of the work piece to be manipulated and a material removal in n layers, this point “belongs” to n different polygons from n different polygon networks.

Thus, the polygons can either share a texture bitmap or they are distributed in more than one-to maximally n-bitmaps.

With respect to the corresponding texture bitmaps, it should be noted that when several bitmaps are present, the removal of a respective material layer is spread over each of the bitmaps. This means, the final material removal at a certain spot is due to addition of each of the grey level values of the texture bitmap at this particular point.

For further reducing the separating line-error, a method according to DE 100 329 81 1A can be applied, whereby an overlap region is formed between the work area where the tracks of the laser merge at the cut edge, and the transition points are statistically distributed.

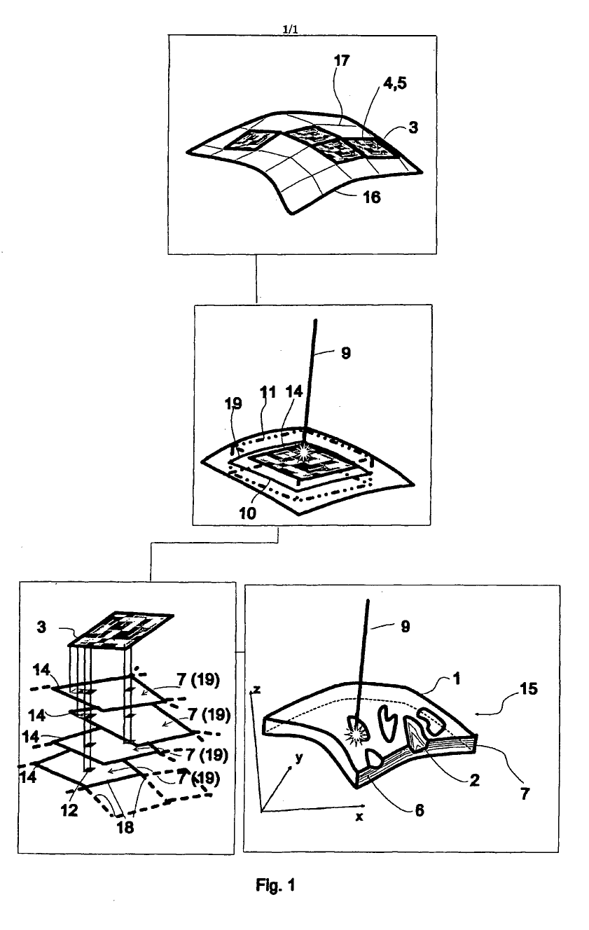

FIG. 1 is a schematic illustration of the method steps sequence.

The single FIGURE shows the steps of the method represented in a schematic way. The method for multilayer removal of material on a work piece (15) having a three-dimensional surface of a desired shape (1) is carried out by means of a removal agent effecting point by point removal (9), such as a laser, by means of which the surface structure (2) on a three-dimensional surface (1) can be realized. On the surface (1), work areas to be worked on (10) are defined, with such a respective area (10) being determined through the focal area (11) of the removal agent. The surface (1) is approximated by superposed polygon networks (18) wherein each of the polygons (19) of the polygon networks (18) is associated with the area to be worked on (10) by the removal agent (9).

The surface structure (2) is described by at least one grey level bitmap (14). The grey level bitmap (14) comprises image spots of various grey level values (12) or various color levels. The grey level brightness (12) corresponding to each image spot of the grey level bitmap (14) or to the intensity of the color level or to the color parameter, such as for example a wave length, when using multicolored bitmaps, determines the depth of the material removal.

The material removal is carried out in a plurality of layers (7) in correspondence to the value of the grey level. Each layer (7) is associated with its own polygon network (18). Each of the polygons to be worked on (19) in each layer (7) does not have a common border edge with any one of the previously worked on polygons in order to avoid negative boundary effects, which could become visible on the surface from the stopping and starting of the removal agent.

When carrying out the method, an original three-dimensional computer model (16) is created of the work piece (15), which is described by an original polygon (17). The three-dimensional corners of the polygon (17) correspond to the two-dimensional spots in one or more master texture bitmaps (3). The polygons are transmitted into the two-dimensional space of the master texture bitmap (3) whereby the grey level value (5) of an image spot (4) on the master texture bitmap (3) corresponds to the requisite removal of material from the work piece (15) and wherein the work areas (10) comprise single layers (7). The sum of those areas (7) results in the surface (1) and the sum of layers (7) makes up the surface structure (2) of the work piece (15). Each layer (7) can be described by a polygon network (18), where the superposed polygon networks are arranged offset from each other. The surface structure (2) of work piece (15) is approximated by polygon networks (18) that are superposed and offset to each other. Each polygon (19) within the work area (10) is associated with a grey level bitmap (14) from a parallel projection of the master texture bitmap (3) onto the polygon (19), so that the removal of material in each layer (7) can be realized by the removal agent (9) in correspondence to the value of the grey level bitmap. The distance value (6) between the two layers (7) thus corresponds to the difference in brightness between the neighboring grey levels (12).

The master model is derived from the description of the work piece through CAD-(spline)-surfaces, resulting in the original polygon network (17).

The brightness values of the grey level (12) of the grey level bitmap (14) are computed backwards to the master texture bitmap, before or during the machining of the surface (1) of the work piece (15). Instead of brightness values of grey levels (12), color levels or colors from the color spectrum can also be utilized.

Reference Numeral List

1. Surface
2. texture=surface structure
3. surface section=master texture bitmap
4. image spot
5. grey level
6. distance value
7. layer
8. free
9. removal agent
10. work area
11. focal area
12. grey level
13. free
14. raster image=grey level bitmap
15. work piece
16. original 3-D computer model
17. original polygon network
18. polygon network of one layer
19. polygon of the polygon network 18

1-10. (canceled)

11. A process for the multi-layered removal of material from a workpiece having an arbitrary shaped three-dimensional surface comprising the steps of:
approximating the surface of the workpiece through a plurality of polygons in the form of superposed polygon networks,
determining work areas to be machined on the three-dimensional surface of the workpiece through the focal cuboid of a removal agent.
assigning each polygon of the polygon network to a work area, and
removing material in a point-wise manner from each work area by the laser, thereby generating a surface structure on the three-dimensional surface.

12. The process according to claim 11, wherein the removal agent is a laser.

13. The process according to claim 11, wherein the surface structure is described by at least one grey level bitmap.

14. The process according to claim 13, wherein the grey level bitmap includes image spots of different grey levels or different color levels.

15. The process according to claim 14, wherein a depth of the material removal is determined by one of, a brightness of the grey level corresponding to each image spot of the grey level bit map or an intensity of the color level.

16. The process according to claim 15, wherein removal of the material is carried out in a number of layers corresponding to a value of the grey level.

17. The process according to claim 16, wherein each of the layers is associated with its own polygon network.

18. The process according to claim 17, wherein each polygon to be manipulated in each layer does not have a border portion in common with a previously manipulated polygon.

19. A process for the multi-layered removal of material from a three-dimensional surface of any shape comprising the steps of:
generating a three-dimensional computer model of the workpiece described by a first polygon network;
providing one or more master texture bitmaps defining two-dimensional spaces; wherein three-dimensional corners of the polygons of the first polygon network correspond to two-dimensional image spots in one or more of the master texture bitmap thereby translating the polygons into the two-dimensional space of the master texture bitmap;
wherein the master texture bitmap comprises a plurality of image spots, each of which is defined by a grey level value corresponding to the material to be removed;
determining work areas to be manipulated for removal of material on the three-dimensional surface of the workpiece by means of locating a work area in the focal square of a removal agent, which is a laser; wherein the work areas comprise single layers, each of the layers describing a polygon network, such that the sum of the work areas correspond to the surface of the workpiece and the sum of the layers correspond to the surface structure of the workpiece;
wherein the surface of the workpiece is approximated through superposing second polygon networks having a plurality of polygons and wherein the superposed polygon networks are offset to each other;
assigning each polygon of each polygon network within the work area with a grey level bitmap from a parallel projection of the master texture bitmap onto the polygon within the work area, and
removing the material by means of the laser in each layer in correspondence to the values of the grey level bitmap.

20. The process according to claim 19, wherein the original computer model is derived from the description of the workpiece by CAD-(spline)-surfaces, which result in an original polygon network.

21. The process according to claim 19, wherein the brightness values of the grey level of the grey level bitmaps either before or during manipulation of the surface of the workpiece are computed back to the master texture bitmap.
